(19) United States
(12) Patent Application Publication
(10) Pub. No.: US 2013/0060873 A1
(43) Pub. Date: Mar. 7, 2013

(54) REAL TIME EVENT REVIEWING SYSTEM AND METHOD

(71) Applicants: Prashant Gautam, Jaipur (IN); Saurabh Agrawal, Varanasi (IN); Anveesh Raghav, Rampur (IN); Ayush Ghai, Mainpura (IN)

(72) Inventors: Prashant Gautam, Jaipur (IN); Saurabh Agrawal, Varanasi (IN); Anveesh Raghav, Rampur (IN); Ayush Ghai, Mainpura (IN)

(73) Assignees: Saurabh Agrawal, Varanasi (IN); Mr. Prashant Gautam, Jaipur (IN)

(21) Appl. No.: 13/596,051

(22) Filed: Aug. 28, 2012

(30) Foreign Application Priority Data
Aug. 29, 2011 (IN) 2445/DEL/2011

(51) Int. Cl. G06F 15/16

(52) U.S. Cl. 709/206

(57) ABSTRACT

Collating real time comments associated with an event enables a user to provide the real time comments on proceedings occurring in the event. The method of collating real time comments comprises providing real time comments for the event, wherein the real time comments are provided on a communication device. Thereafter, identifying a position parameter value of the real time comment by the communication device and sending the comments data to the central server by the communication device, wherein the comments data comprises real time comments and the position parameter values, followed by processing the comments data by the central sewer. Processing of the comments data would further comprise collating the real time comments of the user with real time comments from the plurality of users. The user comments are thus synced using algorithms, with a single timeline of the respective event stored in the central server.

### FIELD OF INVENTION

The present invention is generally related to an event reviewing, and user comments collating method, and more particularly it is related to real time event review generation by associating comments wife the event as and when they are experienced by the user.

### BACKGROUND OF THE INVENTION

With the advent of World Wide Web it has became easy to share and access the vast information available on the internet. Sharing comments, reviews or feedback about books, articles, movies, or even products and services through several internet based online forums has helped new users make a conscious decision for buying books, watching movies, buying products etc. However, one of the limitations with online forums is that they do not represent the reviews, emotions and comments as were experienced while reading the book, watching the movie or while using the product. In case of movies, generally, viewers provide the comments after watching the entire movie.

There have been attempts to devise methods where a user may share real-time comments while watching a movie. In U.S. Patent Application 20090271524, a method has been disclosed where users share their comments in real-time or near-real-time with respect to ‘linear events’ experienced by the users, such as a movie. A network user can utilize his or her input device to submit a comment expressing his or her opinion or reaction as to a particular ‘linear event’ observed by the user. The media displaying device being constantly connected to a media server, has all the information of the attributes related to the media or the movie such as name of the movie, the current scene being viewed by the user, the scene number of the movie, and other similar run-time details of the movie. The run-time details of the movie are maintained by the media server that is continuously connected to the central server. Here, the input device is connected to a central server which gathers the information provided by the user. The central server further has the information of the media displayed to the user as the central server is connected to the media server too. Therefore, the central server is able to synchronize the comments made with the ‘linear event’ timeline. However, a major limitation with the disclosed method is that the central server needs to be continuously connected to the media server to have real time information about the attributes of the ‘linear event’. Further, the method is only applicable for the media streams that are to be broadcasted. Further, the user is not allowed to provide media information or attributes for a new media, which is not scheduled to be broadcasted or is being broadcasted.

A book review online service named BOOKTAGGER exists, which allows a user to tag books read by the user. The user can find the books tagged as per his or her reading tastes. Further, books will be rated based on the tags and comment. However, limitation of this service is that page number wise or chapter wise comment cannot be made in real time or as the user reads the hard copy of the book. Hence, there is a need to provide a method to enable a user capture his emotions, reviews and comments while reading a hard-copy or the paper print edition of the book.

Therefore, there exists a need to capture emotions and comments as they are experienced while reading a book, watching a movie or even watching a live sporting event, etc., without the necessity of an additional server (media server), and create a comprehensive review of the book, the movie or the live sporting event, etc. Further, there is a need to enable the user to provide media information or attributes for a new media, which is not scheduled to be broadcasted or is being broadcasted.

### SUMMARY OF THE INVENTION

The present invention describes a method and a system of collating real time comments associated with an event from a plurality of users enabling a user to provide the real time comments in relation to proceedings occurring in the event. The user uses a communication device to input the real time comments. Here, the ‘real time comments’ refer to the comments, emotions or reviews as are experienced by the user during the event. The comments are captured in real time i.e. the user experiences/emotions are captured during the run or performance of the event and are further send to the central server from the communication device over a communication network at periodic intervals or after the event has ended. The central server receives the real time comments for the event and associates the real time comments with the event using a position parameter related to the type of event. For example, the position parameter could be time-stamp in case where the comments are for a movie, and could be page number where the comments are for a book. The central server associates the time stamps or page numbers, of the real time comments received with the entire timeline of the movie or total pages of the book respectively. Further, the central server generates a real time event review using the real time comments of a plurality of users for the same event and the real time event review is accessible over the communication network, or on a mobile application or on any other display channel from the central server.

In one aspect of the invention the user registers the event on the communication device by providing the details of the event. The details are sent to the central server from the communication device and the event is identified by the central server. In a case where me event is not already available at the central server, the central server stores the event as a new event. A session id is created on the first instance of communication between the central server and the communication device. Thereafter, the user inputs the real time comments on the communication device which are sent to the central server over the communication network by the communication device, as and when the comments are made or at the end of the event being reviewed. The central server receives the real time comments and subsequently stores the real time comments using the session id. The central server synchronizes position parameter value of the real time comments with real time comments from the plurality of users. The processor then analyses the real time comments from different users to generate a comprehensive review of the event. The comprehensive review can be viewed by a viewer by accessing the central server through a user interface such as via a web browser connecting over internet, or as emails, as SMS connecting over telecommunication network, or through any other means or device. Another aspect of the invention is to enable the user to provide the real time comments on the event collectively in an offline mode. The communication device may not be connected with the central server at the time of providing the comments to the event. The user creates an event on the communication device and keeps on providing the real time comments on the proceedings occurring in the event. The communication device locally stores the real time comments made by the user on the communication device. The user may connect the communication device with the central server at any later time and send the collective data of the real time comments and the details of the event to the central server over the communication network.

### BRIEF DESCRIPTION OF THE FIGURES

FIG. 1 illustrates an environment and overview where the invention may be practiced, according to one embodiment of the invention.

FIG. 2 illustrates the system elements of central server, according to an embodiment of the invention.

FIG. 3A, illustrates a flowchart depicting the method steps of practicing the invention according to an embodiment of the invention.

FIG. 3B, illustrates a flowchart depicting the method steps of practicing the invention according to an embodiment of the invention.

FIG. 3C, illustrates a flowchart depicting the method steps of practicing the invention according to an embodiment of the invention.

FIG. 4 illustrates a display of the user interface for providing real time comments for a video event category, by the user according to an embodiment of the invention.

FIG. 5 illustrates an embodiment, where the communication device may be a keypad for enabling plurality of users to provide real time comments to an event in an arena.

### DETAILED DESCRIPTION

The exemplary embodiments, described in this section with details, are provided merely to illustrate the principles of the invention. Various details are set forth for the purpose of explanation rather than limitation. However it will be apparent to a person skilled in the art that the invention can the practiced without these details and the given exemplary embodiments should not be construed as limiting the scope of the invention. The embodiments are described below in order to explain the invention by referring to the figures.

Further, in the invention, communication over the communication network is enabled through any of the communication protocols, such as HTTP (Hyper Text Transfer Protocol) for Internet, and GSM for the examples of mobile communication network. Examples of communication network as well as other definitions have been described below for the sake of clarity. Moreover, general terms that are well known and do not bear much effect on the invention such as processor and likes have not been described for sake of clarity.

Communication device: Communication device may be any device that operates over any communication network and may communicate to server. Examples of communication device include but not limited to laptops, personal desktop computers, mobile phones, PDAs (Personal Digital Assistants), Internet TVs and internet kiosks.

Server: A server is a computer, or series of computers, that link other computers or electronic devices together and is dedicated to running one or more specific services such as processing, data storage and management, email services, web services etc serving the needs of programs running on other computers on the network. The web server for example may deliver (serve) or receive content, such as Web pages, using the Hypertext Transfer Protocol (HTTP), over the World Wide Web.

Website: A Website is a collection of related web pages, images, videos or other digital assets that are addressed with a common domain name or IP address in an Internet Protocol-based network. A Website is hosted on at least one web server, accessible via a network such as the Internet or a private local area network.

Client Application: A client application is software that resides in a user's desktop or laptop computer, PDA, cell phone or any other communication device. Client application exists on the communication device but may use services from a server, Yahoo Messenger™, Picasa™ are examples of software that use services from a server but exist on communication device.

Gateway: A gateway in a communications network is a network node equipped for interfacing with another network that uses different protocols. The network could be implemented in software, hardware or both. Also, a protocol translation/mapping gateway interconnects networks with different network protocol technologies by performing the required protocol conversions.

HTML—HTML stands for Hyper Text Markup Language. A “markup language” is a computer language that describes how a page should be formatted.

Graphical User interface: A graphical user interface is an interface for the interaction of user with the software program or application without the need to do all actions from commands. Graphical display of buttons, windows, menus and icons is accessed by a pointing device for performing a task. GUI examples can be operating systems like Microsoft Windows98, Microsoft Windows Vista, web browsers like Netscape Navigator or Microsoft Internet Explorer and applications like Windows Media Player.

Communication Network: A communication network is a network of telecommunications links and nodes arranged so that messages may be passed from one part of the network to another over multiple links and through various nodes. The examples are GPRS, Internet, 3G, GSM or CDMA and the likes.

Returning to the detailed description, the embodiments disclosed herein enable a user comment, user opinion or a user emotion to be associated with on-the spot or real time proceedings of an event. The real time refers to sections of the event just gone by i.e. occurring at or close to the time of input of the comments. A comment may be text, emotions triggered by some part of the event, intensity of emotions triggered, intensity of likeness or dislikeness towards various parts of the event, ratings on a particular aspect of the event etc. Thus, the real time comments refer to the comments, opinions or emotions provided by the user during the run of the event as the event is experienced by the user.

Further, the term ‘event’ as used herein will refer to any subject of review, happening, occurrence, performance, incident, or any other activity for which a user provides real time comments. The event will have a fixed or known start and end time. The ‘event’ will have well defined duration in time units, in number of page units, in number of section units or any other units. The ‘units’ here refers to the finite intervals, parts, sections or divisions between the beginning and end of the event and that can be measured. The units or intervals being expressed on a measurement scale whose units may vary depending on the category of the event. The scale will have uniform quantized divisions that will help in measuring percentage completion of the event in relevant units. Some examples of events and corresponding units may be:

1. Event: Watching a movie (Has a well defined beginning, is of finite duration and has a well defined end), unit of scale: time, least count: 1 second/1 minute,

2. Event: Reading a book, unit of scale: page number/paragraph number/line number/section number, least count: 1 page/1 paragraph/1 line/1 section

3. Event: Watching a live baseball match (beginning: 1st pitch of 1st innings, end: last pitch of the 18th inning, length of the event defined by number of innings), unit of scale: number of pitches, least count: 1 pitch

4. Event: Watching a music concert live (having scheduled beginning and scheduled end), unit of Scale: Time, least count: 1 minute.

Thus, examples of ‘event’ that can have well defined duration in time units may include, but not limited to, live performances such as live singing performance, live sporting events such as a soccer match, any media broadcast (such as a movie, video, audio etc) over internet, GPRS, television, radio etc, a movie show in a movie theatre, playing of a media content on a portable media player including VCR, CD/DVD/HD Media/Blue-Ray player, a laptop/desktop or any other personal device etc. Further, examples of ‘event’ where well defined duration can be in number of page units, number of section units etc, may include book-reading activity either online over e-book readers such as Kindle™, iPad™ etc or reading a paper-book edition (hard copy). Also, an office meeting, a public gathering, online review of a product or service usage may also be termed as an event.

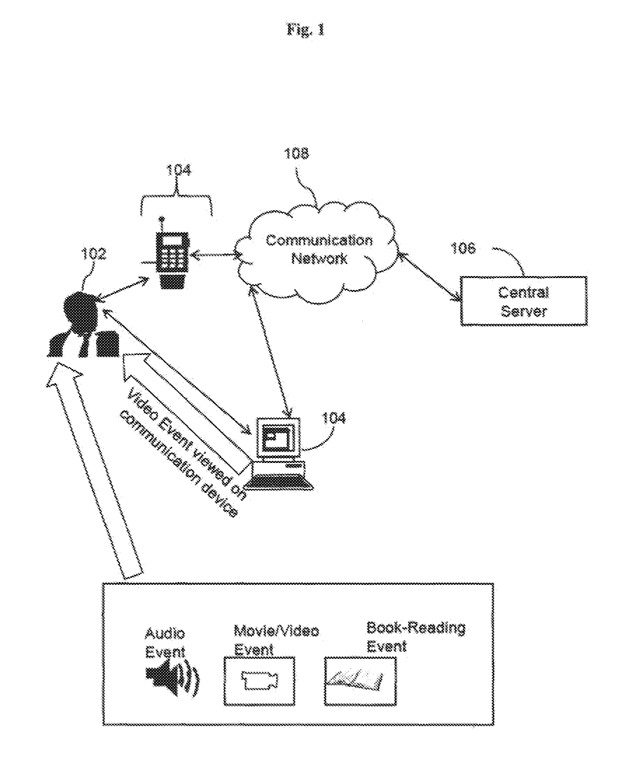

FIG. 1 illustrates an environment and overview where the invention may be practiced, according to one embodiment of the invention. Illustratively, in the environment there exists a user 102 possessing a communication device 104. The user 102, while consuming (i.e. watching or listening) an event provides real time comments on the sequence of the event presented to him using the communication device 104. The real time comments are then intermittently or at the end of the event transmitted to a central server 106 via communication network 108. The comment, opinion or emotion of the user may include texts, any alphanumeric or symbolic input for expressing the opinion of the user 102.

The communication device 104 may be any device such as mobile phone, PDA, laptop, desktop or any other electronic gadget, that enables the user 102 to input comments for an event. In another embodiment of the invention, the user 102 may experience the event on the communication device 104 itself. In the embodiment, the user 102 may experience the event as well as provide his comments on the same device. The communication device 104 presents the event content and a user interface to input real time comments for the event. In yet another embodiment of the invention, the communication device 104 may be an electronic gadget that can automatically detect and record the physiological condition of the user 102. The physiological conditions like heart rate, pulse rate, blood pressure and other related measurable physiological properties of the user 102 may be used as an indicator of the emotions of the user 102 in real time. The real time physiological conditions would thus act as real time comments for an event. It would be apparent to a person skilled in the art that the real time physiological conditions can be suitably interpreted as an emotion or comment. Further, for the purpose of explanation of the detailed description and the claims, the meaning of the term ‘providing’, wherein the user 102 provides real time comments to the communication device 104, would also mean and imply automatic detection of the physiological conditions of the user 102 by the communication device 104. Thus, in the embodiment the user 102 would passively (as the emotions will be recorded automatically) provide real time comments to an event as it is experienced.

In yet another embodiment of the invention, the communication device 104 may be enabled to detect and record gesture of the user 102. Gestures can originate from any bodily motion or state of the user 102 but typically originate from the face or hand. The communication device 104 may also record the motion of the communication device 104. As the user 102 experiences an event the gesture of the user 102 and the motion of the communication device 104 is analyzed and mathematically interpreted as an emotion or comment of the user 102. The interpreted comments or emotions (the real time comments) are then transmitted to the central server 104 as discussed below, where these are collated with the real time comments from plurality of users. Thus, a comprehensive event review is generated.

User: ‘User’ refers to an individual who uses the communication device 104 for inputting comments to an event. Further, ‘event’ may be broadly classified into categories such as video event, audio event, book-reading event and live event.

Video Event: A video event can be defined as any event in which the user 102 views a video content and provide his comments while watching the video content. The examples of a video event may include but not limited to movie show in a movie theatre, playing of media content on portable media player, television, mobile, laptop or any other personal device. In the preferred embodiment the comments represent real time comments, opinion or emotion of the user in real time about the content being viewed, close to the moment of submitting the comment i.e. expressing the opinions and emotions on the sequences, scenes in the video as and when the said sequences or scenes are viewed by the user.

Audio Event: An audio event can be defined as any event in which the user 102 listens to an audio content such as a song, speech, lecture, story, news etc over radio, internet, GPRS or any other communication means and provides his comments while listening to the audio content. In the preferred embodiment the comments represent real time comments, opinion or emotion of the user in real time about the audio content being listened to, close to the moment of submitting the comment i.e. expressing the opinions and emotions on the audio portions as and when the said audio portions are listened by the user.

Book-Reading Event: A book reading event can be defined as any event in which the user reads any documented text over an electronic device or non-electronic device, and provides his comments. Book Reading Event includes reading a book over e-book readers such as Kindle™, iPad™, reading a book online in a web-browsing device over the internet, or reading a paper-book edition (hard copy) of the book. In the preferred embodiment the user 102 provides comments while reading the text of the book, wherein the comment represents opinions/emotions of the user about the specific part of text currently being read by the user. The part of books that can be used as identifiers for the portions of the book being read can include page number, chapter number, column number, line number, paragraph number, figure numbers, numbered annotations and index section of the book.

Live Event: A live event may be defined as any event where the user 102 witnesses a live performance or competition such as a live award ceremony, live sporting event (say a tennis match being witnessed live), live speech, etc and provides his comments while viewing the live event. In the preferred embodiment the comments represent real time comments, opinion or emotion of the user in the real time about the live event being viewed, close to the moment of submitting the comment i.e. expressing the opinions and emotions on the live event happenings as and when the said happenings are viewed by the user.

Returning to the description of FIG. 1, the real time comments being transmitted intermittently to the central server 106 are synced and stored in the central server 106. The central server 106 receives real time comments from plurality of users from various locations around the globe. The real time comments from plurality of users are thus collated to produce a comprehensive and dynamic review of the event.

It may be noted that the spontaneous comments and emotions of the user 102 on specific portions such as a specific sequence in a video event, audio portions in the audio event, specific portions in a book being read during a book-reading event, live sequence while witnessing a live event, are synced and stored in the central server 106. The user comment and the corresponding position parameter value e.g. time stamp in a video, live or an audio event, page number in a book reading event that identifies the specific location in the event at the instant the user comment is also recorded and transmitted to the central server 106. Here, ate position parameter refers to units such as a time unit or page unit for determining beginning of the event, end of the event and the extent of proceeding of the event between beginning and the end of the event. Examples of the position parameter may be page number, chapter number, paragraph or line number in case of a book reading event and may be the ‘time stamps’ or ‘time duration’ in case of a video event, live event or an audio event. It may be apparent to a person skilled in the art that the position parameter may be determined in units of time (say in seconds, hours or days) for a video event, live event or an audio event and may be determined in units of page number, chapter number, paragraph or line number in case of a book reading event,

The central server 106 processes the user comments and the corresponding position parameter values for different types of events. For example, during a book-reading event the comments of a user along with specific page numbers are stored for the book being read. The page numbers are then analysed further for enabling syncing of comments from the plurality of users. This can be illustrated through an example where one user may provide his comment for ‘page number 53’ of a book wherein another user subsequently provides a comment for the paragraph 2 of the ‘page number 53’. Here the two comments are processed by the central server and are essentially synced at same location of ‘page number 53’ with a further detailing about specific paragraphs. In yet another illustration during a live event say a ‘cricket match’ users may provide comments on specific deliveries bowled in an over, say 24^{th} over. However, as the communication device stores the comments based on ‘overs’, it may not accurately store the micro details of per ball or per ‘delivery’ details. Hence, the central server 106 processes the comments for a range of parameter values, in this case an ‘over’. In yet another embodiment, the communication device 104 present the user 102 options to enter the comments for different position parameter values at any given time. For example, while viewing a cricket match, the user may provide comment for a particular ball bowled in say 24^{th} over or may choose to comment for the complete over itself. The comments along with corresponding position parameter values are appropriately stored in the central server 106. It may be noted that different algorithms and methods may be used to enter the comments for different position parameter values by the user, processing the comments data and storing of the comments data at the central server, without effecting the novelty of the invention.

Thus, reviews, comments, emotions and opinions from a large number of users who have consumed (listened or watched) the event are collated at the central server 106. The collated dynamic (as the review is being continuously updated by different users) review for the event and for the specific portions of the event may be accessed by a consumer for receiving a comprehensive feedback or review for the event.

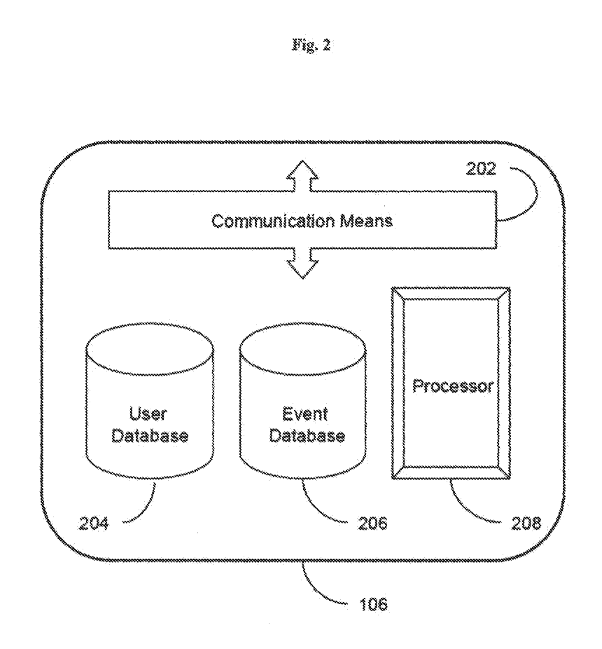

FIG. 2 illustrates the elements of the central server 106, according to an embodiment of the invention. The central server 106 comprising a communication means 202 for communicating with the communication device 104, a user database 204 for storing user data, an event database 206 for storing comments data and the event details, and a processor 208 for processing the user data, the comments data and the event details received from the communication device 104. The various elements have been included herein to describe the central server 106 for practicing due invention and by no means present a limitation to the system.

The user 102 while consuming (listening or viewing) an event may provide his real time comments using the communication device 104. The user 102 at any time before the start of the event chooses the category of the event from one of audio, video, book-reading or live event categories, on the communication device 104. Once the event is chosen and the communication device 104 automatically connects with the central server 106. A unique session id is created on the central server 106 that keeps track of communications with the communication device 104 till the event is over. The communication device 104 acting as an input device to the user 102 has a device application installed on it. The device application when activated or run presents a user interface to the user 102 with user-friendly options and icons. The device application is application software, also known as an application or an “app”, which is machine specific software (computer, mobile or any other machine specific device) designed to help the user to perform singular or multiple related specific tasks. The device application is capable of changing the user interface and/or even programming input buttons of the communication device 104 so as to enable the user 102 effectively enter his comments. The user 102 after choosing the category of the event may enter the event details to be consumed. The event details may include but not necessarily the title or name of the event, the start-time and end time of the event position parameter and any other details. In an another embodiment of the invention the device application itself enables the communication device 104 to input the event details directly from online resources, wherein the details of the event are available over the internet. The user 102 may choose to search an event title online and then the event details are automatically captured by the device application from the online resource. It would be apparent to a person skilled in the art that the device application may enable other methods of inputs such as barcode scanning of book titles, products, DVDs etc. The barcode or ISBN code in case of books may provide the information about the book such as title of the book, author, edition of the book etc. All this information may form the part of the event details. Further, the device application records user data of the user 102 such as name, nickname, and device id of the communication device 104 (such as Mac id of a laptop). Optionally user data may also comprise login details (name and password) of the user 102. The user data and the event details are sent to the central server 106 at the time of the creation of the unique session id. Thus, with the creation of a unique session id for the event, all the event details and user data are recorded at the central server 106.

The user 102 provides real time comments on the various portions of the event through the user interface. In an embodiment of the invention, the device application stores the real time comments along with the corresponding position parameter values in the communication device as comments data through the run of the event. In yet another embodiment the device may send the comments data to the central server 106 as soon as it is received from the user 102 in the communication device 104. The device application may automatically send the comments data at regular intervals to the central server 106. In another embodiment the device application can send all the comments data automatically at the end of the event. In yet another embodiment the comments data can be synced and sent by the user 102 using the communication device 106. The central server 106 then processes and stores the comments data for the event. Comments data for a specific event from various users and communication devices are collated to produce a comprehensive and dynamic review of the event, as illustrated in following description.

The communication means 202 is a gateway enabling the central server 106 to communicate with the communication device 104 over the communication network 108. The communication means 202 enables receiving the user data, the comments data and the event details from the communication device 104 over the communication network 108. A gateway in a communications network is a network node equipped for interfacing with another network that uses different protocols. The network could be implemented in software, hardware or both. Also, a protocol translation/mapping gateway interconnects networks with different network protocol technologies by performing the required protocol conversions.

At the time of the creation of the session id for the event (i.e. first interaction of the communication device 104 with the central server 106), the processor 208 checks the identity of the user 102 by mapping the user data with the user database 204. In case the user 102 is not identified, the processor 208 registers the user 102 in the user database 204. In an another embodiment the processor 208 does not checks the identify of the user 102. The user 102 may anonymously provide his comments on the event or on any part of the event. Further, the event is checked by the processor 208 in the event database 206. In case the event exists in the event database 206, details of the book are automatically retrieved from the event database 206. Once a session id is successfully created, the processor 208 stores the comments data in appropriate memory locations in the event database 206. In case the event is not present in the event database 206, a new entry for the event (here for example, ‘da vinci code’) is created in the event database 206 by the processor 208 and a session id between the communication device 104 and the central server 104 is created. The communication device 104 at the end of the event sends an end-indicator comment. It would be evident to a person skilled in the art that various database schemas and different computer algorithms may be used to effectively store the comments data in the event database 206 and intelligently sync the comments data with the event details and the user data in the user database 204. It would be apparent to a person skilled in the art that various algorithms may be used where processor 208 can sync the specific event portions with the position parameter values for a given event, for a plurality of users who provide comments data for the event. It would also be evident to a person skilled in the art that various software algorithms may be used to sync the comments data with the event details and the user data in the user database 204 such that every time the comments data is received from the communication device 104, the processor 208 avoids redundancy based on the unique session id. In case the event is not present in the event database 206, a new event is created in the event database 206 by the processor 208. The processor 208 then syncs the comments data and the event details as new entries in the user database 204 and the event database 206.

In an embodiment, the processor 208 analyses the comments data, the user data and event details based on various algorithms and schemes to prepare a comprehensive review of the event. The comprehensive review will be dynamic in nature and will change with new reviews as and when they are provided by plurality of users. Further, any individual can view the comprehensive review of the event by accessing the central server 106 using any mobile phone, a laptop, iPad™, any mobile device or any machine through a user interface such as via a web browser connecting over internet, or may receive the reviews from the central server 106 through emails or as SMS service or through any other means.

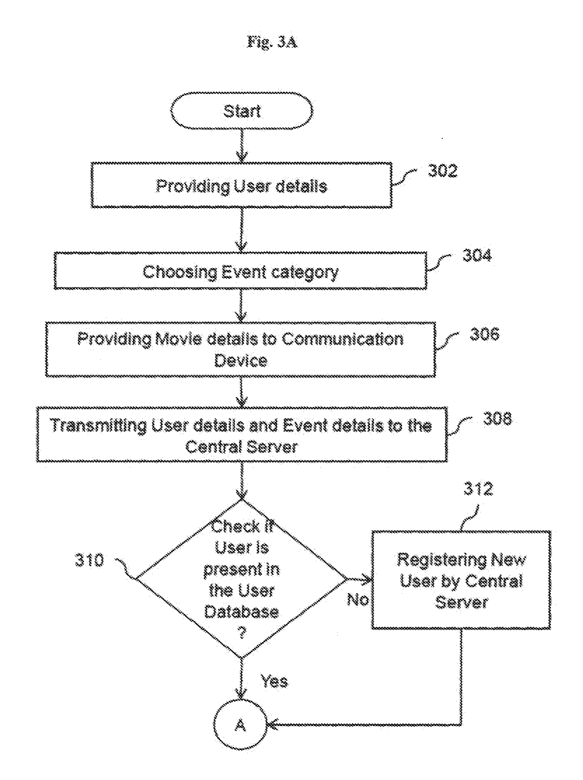

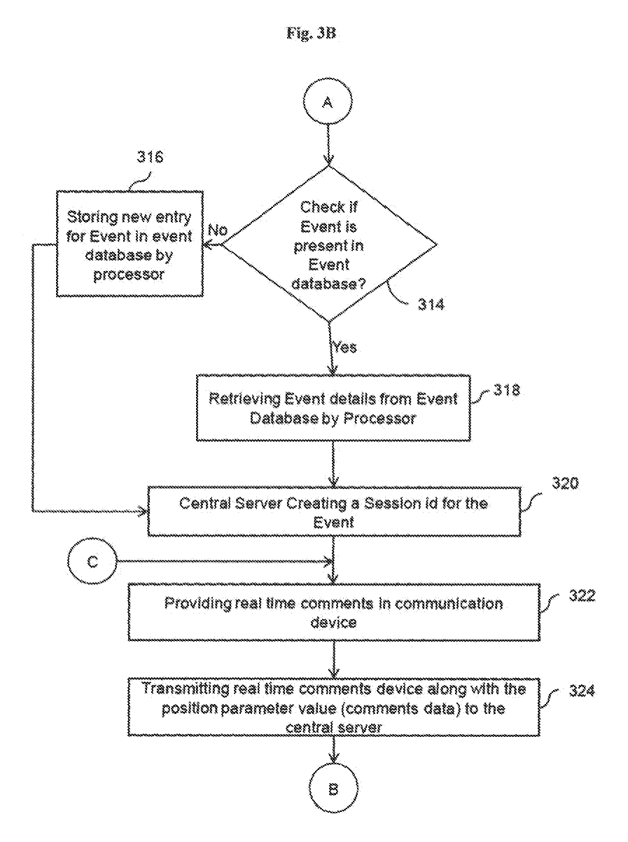

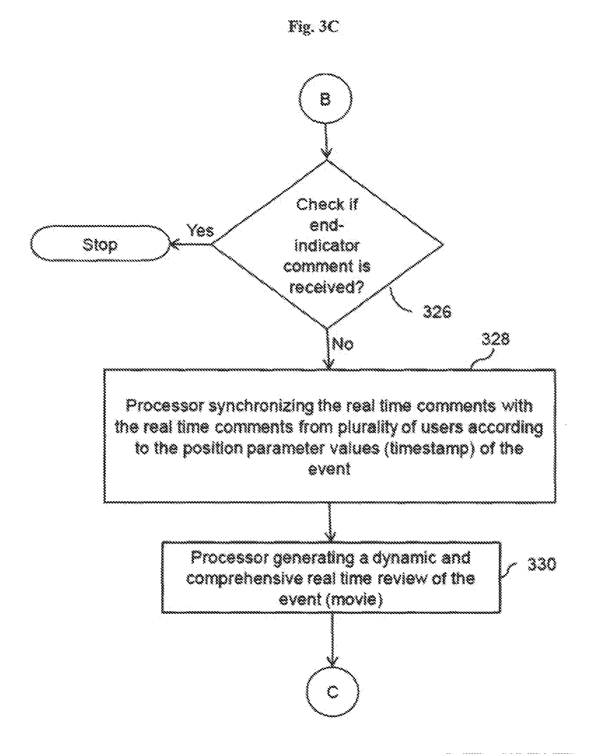

FIGS. 3A, 3B and 3C illustrate a flowchart depicting the method steps of practicing the invention for a video event. As a first step 302, the user details (if not already stored in the communication device 104) are asked by the device application to be provided and stored as user details in the communication device 104. The user details may include ‘nickname’ of the user, machine id of the communication device 104 etc. For example, if the user 102 is using a mobile phone as the communication device then mobile device id is automatically detected by the device application. In the exemplary embodiment the video event is assumed as viewing a movie in a movie theater. The user 102 inputs the event category as movie on the communication device 104 through the device application is step 304. The user 102 is then presented a user interface where he can provide the movie details such as the name of the movie (say ‘The social network’), the start and end time of the movie (say 3 pm and 5.30 pm respectively on 15 May 2010), at the step 306. The user 102 may also provide other details such as the name of the director, the name of the movie theater as the movie details (event details). The user details and event details are transmitted to the central server in step 308.

In the step 310, the processor 208 checks the identity of the user 102 by mapping the user data with the user database 204. In case the user 102 is not identified, the processor 208 registers the user 102 in the user database 204 in the step 312. Further, the movie is checked by the processor 208 in the event database 206 in step 314. In case the movie is not present in the event database 206, a new entry tor the event (for example—‘The social network’) is created in the event database 206 by the processor 208 in step 316. In case the movie (in the example illustrated—“The social network”) exists in the event database 206, the processor 208 retrieves the movie details from the event database 206 in step 318. Further, a unique session id created at step 320 is used to track communications between the central server 106 and the communication device 104. During the movie, the user 102 provides his real time comments, emotions and opinions on the scenes of the movie in real time at step 322 through the user interface on his mobile phone. It may be noted that the device application (here it would be a mobile application) once chosen for the movie event, customizes the input buttons available on the communication device 104 so as to enable the user 102 to enter quick comments, emotions and reviews by tap of the input buttons. The user 102 may enter short symbols, smiley through short-cuts available on the customized user interface on the communication device 104 (mobile phone) as tire real time comments. In an embodiment physiological condition, gesture recognition, mobile phone movement can be detected and interpreted as the real time comments. Here, the time stamps of movie serve as the position parameter. The start time of the movie say 3 pm is considered as the reference point. It may also be possible that the user 102 may choose the start time of the movie (as the actual start time of the movie may differ from a scheduled time). Once the user 102 commences the device application at the start of the movie, the device application stores the start time as the reference time. The user 102 comments during the course of the movie are stored in a chain of the comments data along with the position parameter values on the communication device 104. For example, the user 102 may enter his comment on the opening scene of the film as ‘gripping’ at position parameter value (say time stamp “00:04:23” i.e. approximately four minutes after the start of the movie). The device application stores the comment—‘gripping’ along with position parameter value (“00:04:23”) in the mobile device as tire first comment in the chain of comments in the comments data. The user 102 may also provide a detailed comment say “ . . . the college life of Mark is shown in a very realistic manner . . . I am myself a graduate of the same college!!” at position parameter value (“00:31:26”) when the college sequence is viewed by the user 102 in the movie. Various comments can be added by the user 102 at different time stamps (position parameter values) for different sequences in real time throughout the movie. The plurality of comments and the corresponding position parameter values are stored in the comments data. It may be noted that a range of position parameter values may also be included in the comments data.

The communications device 104 intermittently sends the comments data to the central server 106 over the communication network say via GPRS services at step 324. The unique session id which keeps track of the user 102 as the communication device 104 connects with the central server 106 intermittently is inherent part of all the communications between the communication device 104 and central server 106.

The communication device 104 at the end of the movie sends an end-indicator comment. The end-indicator comment may be automatically sent by the communication device 104 as the stored event details enable the device application to automatically generate the said end-indicator comment. The end-indicator comment may also be sent by the user 102 as he may choose to terminate the session of providing comments for the movie. The central server 106 checks if the message received is an end-indicator comment or the comments data, at step 326. In case the message received from the communication device 104 is comments data indicating continuation of the event (e.g. indicating movie is still being played), the processor 208 synchronizes the real time comments with the real time comments from plurality of users according to the position parameter values (timestamp) of the event (example the movie—‘The social network’) present in the event database 206 at the step 328. The processor 208 calculates the difference between the timestamps of the stored comments and the real time comments of the user 102. The instances where the difference is very small, the processor 208 may adjust the timestamp of the real time comment of the user 102 to match with the timestamps of the stored comments on the movie. Hence, the processor 208 nullifies the error occurring due to delay in submission of the real time comments by the plurality of users. In yet another embodiment, the processor 208 may semantically and statistically analyze the comments data to track the similarities between different comments received for in vicinity of any position parameter value. Say for example, the processor 208 will analyze all the comments received within certain range of the timestamp ‘00:40:01’ (i.e. forty minutes into the movie, all the comments received within say two minutes). Thus, all the comments within timestamp (00:38:01) and (00:42:01) are analyzed to find the semantic similarity and thus are accurately assigned to timestamp ‘00:40:01’. This eliminates minute differences that might have crept in entering comments by user at a particular position in the event. In step 330, the processor 208 generates a dynamic and comprehensive real time movie review of the movie ‘The social network’ by syncing the real time comments of a plurality of users as and when they are received. The communication device 104 again records the emotions and comments of the user 102 as in step 322. The central server 108 listens for the next comments data till the end-indicator comment is received from the communication device.

Furthermore, a viewer wishing to get reviews for the event, may access the real time review of the event (in example a movie—‘the social network’) from the central server 106 by sending a request using a mobile phone, a laptop, iPad™, a mobile device or a machine enabled to present review in an user interface over internet. The viewer may also receive the reviews from the central server 106 through emails or as SMS service or through any other means. It would be apparent to a person skilled in the art that above described embodiment may also be applicable for any other live event, video event or an audio event as well, with similar method steps.

### Embodiment As A Book Reading Event

In a preferred embodiment, the event may be a book-reading event. Here, the user 102 may read a book over a machine interface such as computer screen, Kindle™ etc or may directly read from a hardcopy of the book. It may be noted here that a ‘book’ refers to a commonly known standard piece of text, a story, works of literature etc organized in units such as lines, paragraphs, chapters, etc. Thus, copies of the same book whether in electronic or paper format will have the same units of lines, paragraphs and chapters. The book under same edition and publishers may also have the same page numbers. In an embodiment of the invention, the communication device 104 is a book reading device. For example, an iPad™ acting as a book reading device acts as a communication device 104. The user 102 provides his comments, emotions and opinions as he reads the book over the communication device 104. Here the communication device 104 automatically detects the position (position parameter) where the user 102 is presently reading the book along with other book details such as title of the book, author of the book etc. The position parameter value is detected, which could be the current page number, section number, line reference number, chapter number etc, is captured and stored along with the real time comments of the user 102 on the communication device 104.

In another embodiment of the invention, the book could be in a hard copy format or on Kindle™. The communication device 104 acting as an input device to the user 102 has a device application installed on it. Here the user 102 chooses the book-reading event as a category on the communication device 104 through the device application. The communication device 104 may be any device such as mobile phone, PDA, laptop, desktop or any other electronic gadget, that enables the user 102 to input comments as the user 102 reads the book. The user 102 is then presented a user interface where he can provide the book details such as the title of the book (say ‘da vinci code’), author of the book (for e.g. Dan Brown) to the communication device 104. The book details comprises details including but not limited to title of the book, author of the book, the bar code details of the book, International Standard Book Number (ISBN) or The International Standard Serial Number (ISSN) codes, print edition, publishers' information and the likes.

The device application may present appropriate graphical user-interlace to the user 102 so as to enable easy input of the real time comments based on a chosen position parameter such as page number, chapter number or even reference to particular line numbers for a given chapter or part of the book. It may be noted that the device application (for example, it would the a mobile application for a mobile phone as the communication device) once chosen for the book-reading event, customizes the input buttons available on the communication device 104 so as to enable the user 102 to enter quick comments, emotions and reviews by tap of the input buttons. The user 102 may enter short symbols, smiley through short-cuts available on the customized user interface on the communication device 104. The user 102 while reading the book over any machine interface such as computer screen, Kindle™, iPad™ etc or while directly reading from a hardcopy of the book can enter comments after reading parts/portions of the book. If the book being read is an e-book stored on the communication device 104, the communication device 104 may identity the position parameter value (say page number) automatically. The user 102 may be provided with an option at the event review interface to enable or disable automatic detection of the position parameter value. While reading the book the user 102 provides his real time comments, emotions and opinions on the portions or sequences in the book in real time through the user interface on his communication device 104 (for e.g. in mobile phone) that are stored in the communication device 104 (mobile phone memory) along with the position parameter value as comments data. Here, the page number, chapter number or even line number of the book may serve as the position parameter. The user 102 may provide his real time comments intermittently during the course of reading the book, which are stored in a chain of the comments data along with the position parameter values on the communication device 104. For example, the user 102 may enter his comment on the first few pages of the book as ‘intriguing’ at position parameter value (say page number “04” i.e. approximately on the fourth page of the book). The device application stores the comment—‘intriguing’ along with position parameter value “04”) in the mobile device as the first comment in the chain of comments in the comments data. The user 102 may also provide a detailed comment say “Da Vinci broke with the traditional view of the Last Supper. The clues explained in the book are not readily apparent although well known to those versed in Templar and Priori of Sion legend!!” at position parameter value (page number “50”). Various comments can be added by the user 102 with respect to different page numbers, chapter number (position parameter values) for different sequences in real time throughout the book reading session. The plurality of comments and the corresponding position parameter values are stored in the comments data.

The communication device 104 intermittently sends the comments data to the central server 106 over the communication network say via GPRS services. The communication device 104 starts a session with the central server 106, the first time the user 102 logs in and creates a book reading event on the communication device 104. A unique session id is created by the central server 106 that tracks the communication between the communication device 104 and central server 106. As the unique session id is created user data and book details are registered and stored on the central server 106. During the course of the book reading event, the communication device 104 sends the comments data to the central server 106 which is appropriately stored based on the unique session id. The central server 106 keeps a track of the user 102 by the unique session id as the communication device 104 connects with the central server 106 intermittently. It would be evident to a person skilled in the art that various algorithms may be used to transmit data (comments data, user data and event details) from the communication device 104 to the central server 106 so as to reduce the redundancy of the data and maintain coherency of the data being transferred.

The processor 208 cheeks the identity of the user 102 by mapping the user data with the user database 204. In case the user 102 is not identified, the processor 208 registers the user 102 in the user database 204. Further, the movie is checked fey the processor 208 in the event database 206. In case the book (for example “da vinci code”) exists in the event database 206, details of the book are automatically retrieved from the event database 206. Once a session id is successfully created, the processor 208 stores the comments data. In appropriate memory locations in the event database 206. In case the movie is not present in the event database 206, a new entry for ‘da vinci code’ is created in the event database 206 by the processor 208 and a session id between the communication device 104 and the central server 104 is created. The communication device 104 at the end of the book-reading session sends an end-indicator comment. The end-indicator comment may be automatically sent by the communication device 104, as the book details stored enables the device application to automatically generate the said end-indicator comment after it recognizes the end point of the book. In another embodiment of the invention, the end-indicator comment may also be sent by the user 102 as be may choose to terminate the book reading session. The central server 106 checks if the message received is an end-indicator comment or the comments data. In case the comments data is received from the communication device 104, the comments are appropriately stored and synced with the stored comments on the book.

The processor 208 synchronizes the position parameter values (i.e. page numbers, or chapter numbers, line numbers) of the real time comments with the position parameter values (i.e. page numbers, or chapter numbers, line numbers) of the book (‘da vinci code’) present in the event database 206. The processor 208 generates a dynamic and comprehensive real time book review of the book ‘da vinci code’ by syncing the real time comments of a plurality of users as and when they are received. Any user may access the real time book review of—‘da vinci code’ by accessing the central server 106 through a user interface such as via a web browser connecting over internet, via emails, via SMS connecting over telecommunication network, or through any other means.

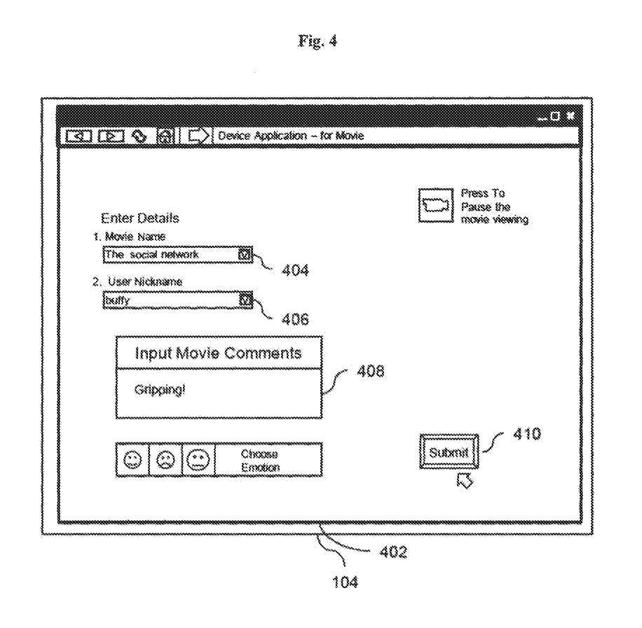

FIG. 4 illustrates a display 402 of the user interface for providing real time comments for a video event category, by the user 102 according to an embodiment of the invention. In the embodiment example, the user interface enables input of the details of the event and the comment details. Illustratively, the user 102 provides movie name 404 and user nickname 406, before inputting any real time comments. The user interface also provides a comment input box 408 for the user 102 to write the real time comments. The user 102 may also choose one of the smileys or short-cut buttons to enter quick comments. The user 102 clicks a submit button 410 to allow the communication device 104 to send the details of the event and the comment details to the central server 106.

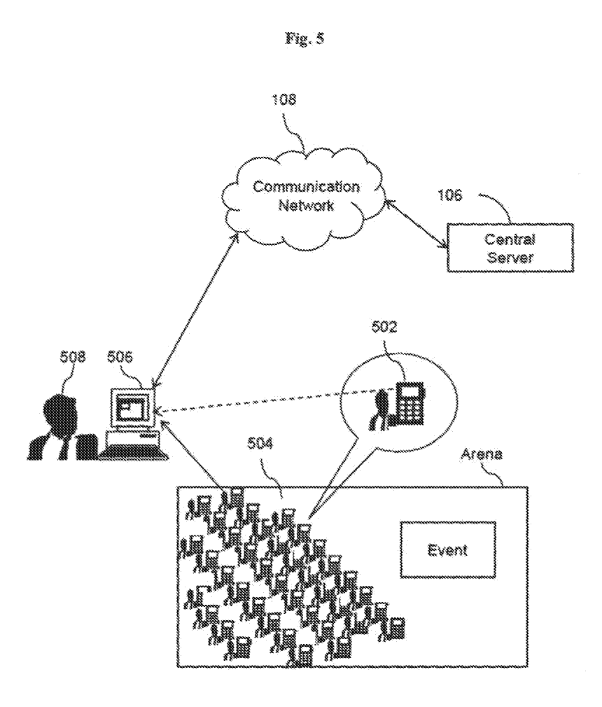

FIG. 5 illustrates an embodiment, where the communication device 104 may be a keypad 502 for enabling plurality of users to provide real time comments to an event in an arena. The environment comprises of an arena where plurality of users 504 are present to view the event in the arena. Examples of arena may include but not limited to a movie theater, a sports stadium such as a tennis tournament court, a cricket stadium, or an auditorium where the users assemble to view a movie, a tennis match, a cricket match or a play respectively. The plurality of users provide their real time comments as they experience the event through the keypads 502 available with each of the plurality of users. The keypad 502 is a device having input buttons, touch screen, switches, or having any other mechanism onto it to provide real time comments on the proceedings of the event by the plurality of users. The keypad 502 available with each of the plurality of users are connected to a communication device 506 that stores the comments of each of the plurality of users. The communication device 506 acting as a local repository of all the real time comments in the arena may intermittently transmit the comments data (comprising comments and corresponding position parameter values) at regular intervals to the central server 106. In another embodiment the communication device 506 can send the comments data automatically at the end of the event. It may be noted that communication device 506 is associated and may be controlled by an administrator 508. Thus, in an embodiment the administrator 508 can send the comments data at any time during the event. The central server 106 comprising the communication means 202 for communicating with the communication device 506, the user database 204 for storing administrator data that will comprise device id of the communication device 506 along with administrator id, the event database 206 for storing comments data and the event details, and the processor 208 for processing the administrator data, the comments data and the event details received from the communication device 104. The comments data is synced and stored with the event, as the processor 208 checks the identity of the administrator 508 by mapping the administrator data with the user database 204. The comprehensive review of the event is thus created by combining and syncing comments from different users and different administrators.

The embodiments of the invention described above are intended for the purpose of illustration only. Numerous modifications, changes, variations, substitutions and equivalents will be apparent to those skilled in the art without departing from the spirit and scope of the invention as described in the claims.

1. A method of collating real time comments associated with an event from a plurality of users enabling a user to provide real time comments to a central server over a communication network, the method comprising steps of:
a) providing real time comments for the event, wherein the real time comments are provided on a communication device;
b) identifying a position parameter value of the real time comment by the communication device;
c) sending the comments data to the central server by the communication device, wherein the comments data comprises real time comments and the position parameter values; and
d) processing the comments data by the central server, wherein processing the comments data further comprising collating the real time comments of the user with real time comments from the plurality of users.

2. The method as recited in claim 1, wherein the user providing the event details including but not limited to event title, start and end time of the event.

3. The method as recited in claim 1, wherein in the step of associating the real time comments with the stored event further comprising the central server synchronizing the position parameter value of the real time comments with the position parameter value of the real time comments from the plurality of users.

4. A method of collating real time comments associated with a video event from a plurality of users, enabling a user to provide real time comments over a communication network to a central server, the method comprising steps of:
a) providing real time comments for the video event, wherein the real time comments are provided on a communication device;
b) identifying time stamp of the real time comments by the communication device;
c) sending the comments data to the central server by the communication device; and
d) processing the comments by the central server, wherein processing the comments data further comprising collating the real time comments of the user with real time comments from the plurality of users.

5. The method as recited in claim 4, wherein the user providing the video event details including but not limited to video title, start and end time of the event.

6. The method as recited in claim 4, wherein the step of associating the comment with the video event further comprising the central server synchronizing the time stamp of the real time comments with the timeline of the real time comments from the plurality of users.

7. A method of collating real time comments associated with a book reading event from a plurality of users, enabling a user to provide real time comments over a communication network to a central server, the method comprising steps of:
a) providing real time comments for the book reading event, wherein the real time comments are provided on a communication device;
b) identifying a position parameter value of the real time comments by the communication device;
c) sending the comments data to the central server from the communication device; and
d) processing the comments by the central server, wherein processing the comments data further comprising collating the real time comments of the user with real time comments from the plurality of users.

8. The method as recited in claim 7, wherein the step of providing the book reading event further comprising the user providing the details of the book reading event including but not limited to book name, author name and user identifier.

9. The method as recited in claim 7, wherein the step of associating the comment data with the book reading event further comprising the central server synchronizing the position parameter value of the real time comments with the position parameter value of real time comments from the plurality of users.

10-14. (canceled)
